(19) United States
(12) Patent Application Publication
(10) Pub. No.: US 2025/0155296 A1
(43) Pub. Date: May 15, 2025

(54) DISTRIBUTED OPTICAL FIBER TEMPERATURE-MEASUREMENT SYSTEM FOR HIGH-TEMPERATURE PIPELINE GROUP

(71) Applicant: HUZHOU INSTITUTE OF ZHEJIANG UNIVERSITY, Huzhou, Zhejiang (CN)

(72) Inventors: Wei YE, Huzhou, Zhejiang (CN); Zhengguo XU, Huzhou, Zhejiang (CN); Kejiang ZHOU, Huzhou, Zhejiang (CN)

(21) Appl. No.: 18/728,412

(22) PCT Filed: Jun. 15, 2022
(86) PCT No.: PCT/CN2022/098871

§ 371 Date: Jul. 11, 2024

(30) Foreign Application Priority Data
Mar. 16, 2022 (CN) 202210255292.8

(51) Int. Cl. G01K 11/324; F17D 5/00; G01K 1/143

(52) U.S. Cl. CPC G01K 11/324; F17D 5/00; G01K 1/143

(57) ABSTRACT

A distributed optical fiber temperature measurement system includes a computer, a data transmission line, a laser emitting apparatus, a wavelength division multiplexing device, a photoelectric detector, a data acquisition card, and optical fibers. A capillary tube is provided outside each optical fiber; the optical fibers form a zigzag form matched with pipelines in a single row; the zigzag form includes columns of straight line sections and arc connecting sections between every two adjacent columns of straight line sections; the straight line sections are shaped to be straight and fixed by the optical fiber shaping frames, the optical fibers are communicated from one end of the zigzag form to the other end, and the straight line sections are fixed on different parallel pipelines one by one by the stainless steel capillary tubes on the outer sides of the straight line sections.

### FIELD OF THE INVENTION

The present invention relates to the technical field of optical fiber temperature-measurement and mounting, particularly to a temperature-measurement technology for each high-temperature pipeline in a boiler high-temperature pipeline group. There may be hundreds or more pipelines in the high-temperature pipeline group, and the pipelines are divided into a plurality of rows.

### BACKGROUND OF THE INVENTION

The electric power industry provides basic power for industry and other sectors of the national economy and is the leading sector in the development of the national economy. As one of the three major facilities in the power plant, the boiler is one of the subsystems with the lowest automation level in the power station system. The leakage of “four tubes” of the boiler includes the leakage from water-cooled wall tubes, superheater tubes, reheater tubes, and economizer tubes. Since the operating conditions of the boiler heating surface become more stringent when more high-parameter and large-capacity units are put into operation, the tubes are prone to corrosion and wear caused by high temperature and high pressure, and the leakage accidents of four tubes may happen. Relevant data show that such accidents account for more than 50% of boiler accidents, and the economic losses of a single accident can exceed one million or even tens of millions of yuan. For example, the superheater groups and reheater groups of a thermal power plant are composed of a large number of parallel pipelines. Their function in the boiler system of a thermal power plant is to absorb the heat of the flue gas and heat the water vapor in the pipelines. The number of input and output pipelines in a single unit can reach tens of thousands. Generally, a type of superheater group pipelines is installed in a certain area on the furnace top. The pipelines are arranged in parallel, and the number of pipelines in a single row is 10-20 or more, and there are dozens of rows of pipelines. The pipeline diameters of different superheater groups, the spacing of adjacent pipelines in a single row of pipelines, and the spacing between rows are different. The pipeline diameter and pipeline spacing are generally tens of millimeters, and the spacing between rows and pipeline length are several hundred millimeters to several meters. When the pipelines leak happens due to factors such as high temperature, corrosion, dust accumulation and aging, major production hazards or accidents to the thermal power generating units will be produced.

The online temperature monitoring of high-temperature pipelines by adopting advanced and reliable technology and processes is implemented to timely and comprehensively grasp and reveal the evolution trends of temperature parameters of various monitored objects, implement intelligent technical analysis work links and accurately and clearly reveal their spatial location, which is of great significance for troubleshooting, preventing the occurrence of vicious accidents, and ensuring the safe production of national and people's property.

Under the trend of large-scale industrial Internet applications, online detection of thermal power generation units is an important approach to improve the efficiency of thermal power generation and improve safety levels. For thousands of high-temperature pipelines in boilers, the distributed optical fiber temperature measurement technology system is installed on the surface of the high-temperature pipelines through the long-distance optical fibers, to form temperature measurement points for each pipeline, which is essentially a temperature measurement early warning application technology system developed on the basis of distributed optical fiber sensing and control technology. The main working principle of this technical system is to apply the technical principle of spontaneous Raman scattering formed during the transmission of optical signals within the optical fiber material, and the technical principle of optical time domain reflection (OTDR) to obtain the temperature distribution information elements in a specific spatial environment. The optical fiber itself not only serves as a temperature sensor, but also exerts the function of signal transmission. Based on OTDR technology, the temperature sensing signals of thousands of pipelines can be obtained calculated and processed, thereby constituting an IoT temperature monitoring system for temperature detection of thousands of high-temperature pipelines.

However, when this technology is applied to distributed temperature detection in high-temperature pipelines, a suitable optical fiber sensor structure must be developed for specific application scenarios of high-temperature environments and pipeline morphological characteristics. If optical fiber is used to measure the temperature of high-temperature pipelines, the optical fiber must inevitably be placed in a high-temperature environment. Although the outside of optical fibers is usually wrapped with a protective coating of polymers such as epoxy acrylate, optical fibers that rely solely on polymer protective coatings are not suitable for high temperature measurement. Optical fibers wrapped with metal film coatings have enhanced high-temperature resistance and can be used for the measurement of high-temperature pipelines. However, if a high-temperature-resistant optical fiber wrapped with a metal film coating is placed in a high-temperature environment, the fiber will become embrittled or even broken due to a series of reasons such as oxidation and physical collision. Therefore, when measuring temperature in a high-temperature environment, the optical fibers need to be penetrated into the stainless steel capillary tube to further protect them. In addition, when measuring the temperature of high-temperature pipelines, according to the principle of distributed optical fiber temperature measurement, to detect the temperature changes at different locations along the optical fiber, the stainless steel capillary tube equipped with optical fibers needs to be bonded to the high-temperature tube wall to be measured.

In practical applications, due to the long-term continuous operation mode of thermal power generating units, the maintenance of high-temperature pipelines and the installation of sensor detection systems can generally only be carried out during shutdown maintenance periods. However, there are generally thousands of high-temperature pipelines of a single thermal power generating unit, and the superheater groups have different functions, and the diameter, length, and spacing of the corresponding high-temperature pipelines, as well as the number of high-temperature pipelines in each row, and the spacing between rows are different; meanwhile, since the actual maintenance work of the thermal power generating unit is generally carried out until the temperature of the high-temperature pipelines of the generating unit cools down from a high temperature state to normal temperature, the downtime of the thermal power generating unit for maintenance is very limited to ensure the thermal power generating unit starts production as soon as possible. Therefore, while meeting the consistency, stability, reliability, etc. for optical fiber installation, it is quite technically difficult to ensure high installation efficiency and short cycle time to complete the above installation within a short maintenance period. If a stainless steel capillary tube equipped with optical fibers is installed directly on the high-temperature pipelines to be tested on site, the detection accuracy is difficult to guarantee and the operation process is cumbersome and time-consuming, specifically as follows:
1, due to the rigidity and elasticity of stainless steel capillary tubes, it is difficult to guarantee that optical fibers are closely bonded to each high-temperature pipeline during the installation on site, which not only reduces the reliability of the installation, but also reduces the accuracy of pipeline temperature measurement;
2, considering that the ambient temperature during actual installation is room temperature, and the boiler operates at high temperature after installation, to reduce the deformation effect of its high-temperature pipelines from room temperature to high temperature, the optical fiber sensors are installed in a straight line mode to fit the pipelines; meanwhile, to ensure the consistency of temperature measurement, it is necessary to ensure that the optical fibers are installed in the same mode, i.e., installed in a straight line along the pipelines. How to guarantee thousands of pipelines have the same straight-line fit without causing tilted installation, twisted installation, etc. during on-site installation is an important link to ensure the consistency of temperature measurement while not affecting the positioning accuracy of temperature measurement;
3, in the optical fiber temperature measurement technology based on OTDR, the temperature positioning is based on the product of the forward propagation and reflection time of light in the optical fiber and the propagation speed of light in the optical fiber as the basis for the temperature measurement position. The propagation speed of light in the optical fiber is extremely fast, and the propagation time of a 1 km optical fiber is only a few microseconds. Therefore, during optical fiber installation, it is necessary to ensure that the optical fiber length is suitable for the specific superheater group pipeline, and the length specific to the same type of superheater group pipeline is completely consistent, otherwise the positioning accuracy of the temperature measurement position will be seriously affected, and positioning errors will be easily accumulated with the increase in the optical fiber length.
4, as mentioned above, there are thousands of different types of high-temperature pipelines. When matching different superheater groups with appropriate fiber lengths, the temperature measurement point should theoretically be the midpoint of the fiber section. In the positioning calculation of each pipeline by the optical fiber temperature measurement system, it is necessary to ensure the consistency of the straight-line fit during installation, the length of the optical fiber on the pipeline and the connection length between pipelines, and the connection length of different rows of pipelines. The on-site installation is difficult to meet the above requirements; meanwhile, positioning calculations also need to consider the length of the optical fiber entering the furnace from outside the furnace and the delay effect on light caused by the length of optical fiber devices such as wavelength division multiplexers after the light is emitted from the laser generating device. During direst installation on site, due to the harsh environment in the furnace, it is more difficult to calculate the length, which leads to increased installation time and calculation errors;
5, considering the limited time for maintenance operations, direct installation on site cannot guarantee a high-precision optical fiber installation process within a limited time to ensure the overall technical performance of the optical fiber temperature measurement system;

Based on the above analysis, for the high-temperature pipeline group containing a large number of high-temperature pipelines, how to solve the temperature measurement accuracy, temperature measurement consistency, stability, reliability and temperature measurement positioning accuracy is an urgent issue of important economic and social significance that needs to be solved to ensure the safe operation of the power industry.

### SUMMARY OF THE INVENTION

An object of the present invention is to provide a distributed optical fiber temperature measurement system for a high-temperature pipeline group, which has higher measurement accuracy and is convenient to mount. In order to achieve the above object, the present invention adopts the following technical solutions:

A distributed optical fiber temperature measurement system for a high-temperature pipeline group comprises an upper computer, a data transmission line, a laser emitting apparatus, a wavelength division multiplexing device, a photoelectric detector, a high-speed data acquisition card, and sensing temperature-measurement optical fibers. A stainless steel capillary tube is provided outside each sensing temperature-measurement optical fiber; wherein the optical fibers are placed in the stainless steel capillary tube, and are shaped by optical fiber shaping frames to form a single-optical-fiber multi-path back-and-forth zigzag structural form matched with a plurality of high-temperature pipelines in a single row; since the back-and-forth optical fibers are on the same plane when shaped, they are defined as one back-and-forth zigzag shape. The back-and-forth zigzag form comprises a plurality of columns of straight line sections and arc connecting sections between every two adjacent columns of straight line sections; the straight line sections are shaped to be straight and fixed in length by the optical fiber shaping frames, the straight line sections are equal in length, and the arc connecting sections are equal in length; and the sensing temperature-measurement optical fibers are communicated from one end of the multi-path back-and-forth zigzag form to the other end, and the straight line sections are fixed on different parallel high-temperature pipelines one by one by means of the stainless steel capillary tubes on the outer sides of the straight line sections.

On the basis of adopting the above technical solutions, the present invention can also adopt the following further technical solutions, or use these further technical solutions in combination:

The optical fibers are shaped by an optical fiber shaping frame to be an integral multiple of (L0+L1/2) to (L1+L2); wherein, L0 is the length of a single-path optical fiber connected to the starting position of an optical fiber straight line section corresponding to a first high-temperature pipeline by a wavelength division multiplexing device, L1 is the length of the optical fiber straight line section, and L2 is the length between the tail end of the previous optical fiber straight line section and the starting point of the next optical fiber straight line section in the same row.

For the connecting optical fibers between the rows of pipelines, the optical fiber length L3 from the tail end of the last straight line section in the previous row to the starting end of the first straight line section in the next row is an integral multiple of (L1+L2), or the length obtained after accumulative error elimination treatment is carried out on the basis of the integral multiple of (L1+L2).

When there are a plurality of rows of the high-temperature pipelines, the accumulative error is eliminated by adjusting the length of the connecting optical fibers between the rows.

The optical fiber shaping frame is provided with a back-and-forth zigzag positioning groove matched with the stainless steel capillary tube; the back-and-forth zigzag positioning groove includes a plurality of columns of linear positioning grooves, and arc connecting positioning grooves between two adjacent columns of linear positioning grooves at the front and rear, and the spacing between the linear positioning grooves corresponds to the spacing between every two adjacent high-temperature pipelines; and the cross section size of the positioning groove meets the requirement that part of the stainless steel capillary tube can be embedded.

The back-and-forth zigzag positioning groove is formed by combining a plurality of shaping modules, and the shaping modules include linear long shaping plate modules, linear short shaping plate modules and arc connecting shaping plate modules; linear positioning grooves are formed in the surfaces of the linear long shaping plate modules and the surfaces of the linear short shaping plate modules; arc connecting positioning grooves are formed in the surfaces of the arc connecting shaping plate modules; the positioning grooves of the adjacent shaping modules are joined and communicated; the shaping modules are further provided with pressing plates; and the pressing plates are connected with the shaping modules and used for pressing, shaping and straightening optical fibers.

A column of linear positioning grooves is formed by combining a plurality of linear shaping modules; and the adjacent columns of linear positioning grooves are sequentially connected through the arc connecting shaping plate modules to form the back-and-forth zigzag positioning groove.

A fixing structure includes supporting frames on the two sides; the supporting frames on the two sides are provided with connecting structures for single-row optical fiber shaping frames; cross beams are connected between the connecting structures of the supporting frames on the two sides; a plurality of cross beams with different heights are arranged in the single-row optical fiber shaping frames; and a plurality of shaping module mounting positions are arranged on the cross beams in the length direction so as to adjust the spacing between different rows of shaping modules to be matched with the spacing change between the high-temperature pipelines on a test site. The length of the cross beams can be customized according to the specific width of each row of high-temperature pipelines on the test site. The supporting frame includes an ejector rod and a base; a stand column is connected between the ejector rod and the base; the cross beams are connected with the stand column; and the stand column is connected with the ejector rod and the base in a position-adjustable mode, and the spacing between the adjacent single-row optical fiber shaping frames can be adjusted. Therefore, the position of each straight line section of the optical fiber can completely adapt to each high-temperature pipeline arranged in a whole column mode; and the length of the optical fibers can be standardized when the optical fibers are connected from one row to the other row, thus materials are saved, and the optical fibers are protected against damage caused by mistaken regular hanging.

A plurality of mounting positions can be arranged on the stand column in the length direction, and the cross beams can be selectively mounted on the mounting positions to adapt to different module combination forms so as to adapt to different high-temperature pipeline lengths.

Through combination and connection of different shaping modules on the fixing structure, a plurality of linear long shaping plate modules and linear short shaping plate modules form a column of linear positioning grooves, and the lengths can be adjusted according to different types of high-temperature pipelines, and every two adjacent columns are connected through the arc connecting shaping plate modules; the arc connecting shaping plate modules can adjust the spacing according to different types of high-temperature pipelines by arranging arc connecting positioning grooves with different diameters or dividing the arc connecting shaping plate modules into a left half and a right half, or adjust the length of sensing temperature-measurement optical fibers of a bent part in each groove by adjusting the spacing between the left half and the right half.

Through holes are formed in the shaping modules; internal threads are arranged in the inner walls of the through holes; the pressing plates include a long pressing plate and a short pressing plate, and the two are distributed with the same through holes at the corresponding same position with the long shaping plates and the short shaping plates, and the pressing plates are fixed to the long shaping plates and the short shaping plates through the through holes and bolts.

The outer diameter of the stainless steel capillary tube is smaller than 3.5 mm, and the inner diameter is larger than the diameter of the sensing temperature-measurement optical fibers; and the width and the depth of each positioning groove are not larger than 4 mm but larger than the outer diameter of the stainless steel capillary tube.

Further, the sensing temperature-measurement optical fibers are shaped through the following steps:
Step (1): adjusting the number of the single-row optical fiber shaping frames in an optical fiber shaping bent frame and the distance between the single-row optical fiber shaping frames in the adjacent rows according to the row number of the high-temperature pipelines, the row-to-row spacing, the spacing between the high-temperature pipelines in each row and the length of the single high-temperature pipeline in the test site, selecting proper shaping modules, and determining the spacing between linear positioning grooves in the single-row optical fiber shaping frames and the length of the linear positioning grooves;
Step (2): enabling one end of the stainless steel capillary tube with the sensing temperature-measurement optical fibers to enter from one end of the optical fiber positioning groove of the single-row optical fiber shaping frame in the first row in the optical fiber shaping bent frame and exit from the other end, and then entering the optical fiber positioning groove of the single-row optical fiber shaping frame in the next row from one end and exiting from the other end in the same manner until one end of the stainless steel capillary tube enters from one end of the optical fiber positioning groove of the single-row optical fiber shaping frame in the last row and exits from the other end; and
Step (3): fixing the pressing plates to the shaping modules of the optical fiber shaping bent frame, and flattening the stainless steel capillary tube with the sensing temperature-measurement optical fibers so that the stainless steel capillary tube with the sensing temperature-measurement optical fibers forms a plurality of back-and-forth zigzag shapes, the spacing between two adjacent straight line sections in the same back-and-forth zigzag shape corresponds to the spacing between two adjacent high-temperature pipelines in the same row, and the spacing between the stainless steel capillary tubes with the sensing temperature-measurement optical fibers connected between the adjacent back-and-forth zigzag shapes is matched with the spacing between the adjacent high-temperature pipelines.

A distributed optical fiber temperature-measurement system is further provided with a high-temperature-resistant shaping plate; after being successfully shaped, the optical fibers are accurately mounted on the high-temperature pipelines at a time through the following steps:
Step (1): after the stainless steel capillary tube with the sensing temperature-measurement optical fibers are successfully shaped, taking down the pressing plates, connecting the outer side surface of the stainless steel capillary tube with the sensing temperature-measurement optical fibers on each single-row optical fiber shaping frame to the high-temperature-resistant shaping plate, and taking down the high-temperature-resistant shaping plate connected with the stainless steel capillary tube with the sensing temperature-measurement optical fibers from each optical fiber shaping frame to form a plurality of mounting structures which can be overlapped but are connected with one another and are communicated with one another from one ends to the other ends of the stainless steel capillary tubes with the sensing temperature-measurement optical fibers; and
step (2): inserting a single-row high-temperature-resistant plate fixedly provided with one stainless steel capillary tube with the sensing temperature-measurement optical fibers into the front of a corresponding row of high-temperature pipelines on the test site, enabling the stainless steel capillary tube at the straight line section to be in one-to-one correspondence with each high-temperature pipeline, and attaching and fixing the stainless steel capillary tube at the straight line section to the high-temperature pipelines, one stainless steel capillary tube with the sensing temperature-measurement optical fibers corresponding to one row of high-temperature pipelines.

Further, every two stainless steel capillary tubes with the sensing temperature-measurement optical fibers are arranged face to face, and the workload of arc connecting sections in the mounting process is reduced.

In the distributed optical fiber temperature-measurement system for a large number of high-temperature pipelines, positioning a temperature measuring point of each pipeline is the core technical problem. The straight line sections are shaped to be straight and fixed in length by the optical fiber shaping frames, the straight line sections are equal in length, and the arc connecting sections are equal in length.

This problem can be well solved through the shaped optical fiber sensor structure.

The propagation speed of light in the optical fibers is obtained by dividing the light speed in vacuum by the effective refractive index of an optical fiber core, and is determined by the physical property of the optical fiber. An optical signal is emitted into the optical fibers, the position relation between a scattering point and the incident end of the optical fiber can be calculated according to the time difference T between the emitting time of incident light and the time when a backward Raman scattering signal is received, and the calculation formula is shown as follows:

$$d = \frac{c τ}{2 n} \qquad ( 1 )$$

Where, d is the optical fiber length from the corresponding scattering point to the incident point in the optical fibers; c is the propagation speed in light vacuum; n is the effective refractive index of the optical fiber core; and c/n is the propagation speed of light in the optical fibers.

Based on the OTDR principle, optical fiber reflection signals are sampled by high-speed AD. The setting of the AD sampling frequency is determined based on the distribution characteristics of pipeline temperature-measurement points. It is assumed that after the output of a laser passes through a wavelength division multiplexing device, the length of the initial position connected to the first pipeline is L0, and the length can be conveniently measured in a laboratory after the system is built;
it is assumed that the length of an optical fiber straight line section mounted on a specific high-temperature pipeline is L1, the length of an arc connecting section between the optical fiber straight line sections of two pipelines is L2, and the optical fiber length required for a single pipeline is (L1+L2). Because the shaping frame is adopted for shaping the optical fiber sensor structure, the length (L1+L2) is the same for other pipelines in the row, and good consistency is achieved;
it is assumed that the number of the pipelines in each row is M, and the total length of the optical fibers in the row is (L1+L2)*M;
as described above, the temperature-measurement point of each pipeline is to be selected at the midpoint of the pipeline, namely the position of L1/2, so that the distance between the measurement point of the first pipeline and the laser is (L0+L1/2), the position of the measurement point of the pipeline in the row may be expressed as (L0+L1/2+ (L1+L2)*(N−1)), and N is the number of the pipelines (N=1, 2 . . . . M) in the row. Because the optical fibers are shaped, L1 and L2 are the same, the positioning position may be easily calculated and obtained, and the precision is extremely high;
thus, according to the solution of the present invention, “group” data measurement in a high-temperature severe environment is converted into a regular repeated event which is very simple and higher in precision.

According to the Formula 1, the time T of the light for passing through the length of (L1+L2) in the optical fibers may be calculated:
T=2n(L1+L2)/c, and the AD sampling frequency of the time Tis f=1/T;
in the above process, it can be guaranteed that the temperature-measurement point is just the midpoint of the pipeline based on the sampling frequency only by guaranteeing that (L0+L1/2) is an integral multiple of (L1+L2). L0 is the length of the single optical fiber at the initial position of the optical fiber straight line section, corresponding to a first high-temperature pipeline, connected to a wavelength division multiplexer, L1 is the length of the optical fiber straight line section, L2 is the length between the tail end of the previous optical fiber straight line section and the starting point of the next optical fiber straight line section in the same row. L0 may be obtained by adjusting the length of an optical fiber extension line welded to a tail fiber of the wavelength division multiplexer in the development process of a laboratory sensing detection system.

Similarly, for rows of pipelines, it is assumed that the length of the optical fibers between the rows is L3 (namely the length of the optical fibers between the tail end of the last straight line section in the previous row and the starting end of the first straight line section in the next row), and because the distance between the rows of the shaping frame may be adjusted, it can be guaranteed that the temperature-measurement point of each high-temperature pipeline in the second row is located at the midpoint of the pipeline only by adjusting L3 to be an integral multiple of (L1+L2), and the rest can be done in the same manner.

It can be known from the above that under the condition that the high-temperature pipelines are arranged in a plurality of rows, the lengths L1 of straight line sections in each row are equal, and the arc connecting sections are equal in length L2 (the length between the tail end of the previous straight line section and the starting point of the next straight line section); and all the rows are equal in L1, and all the rows are also equal in L2, so the solution is a preferred solution.

In a word, because the sensing optical fibers are strictly shaped, the position precision of the sensing optical fibers is guaranteed by the machining precision; and based on the calculation process, high-precision temperature detection positioning can be easily achieved in software programming.

Along with the extension of the length of the optical fibers, a certain accumulative error is inevitably caused for the positioning of the temperature-measurement point of each subsequent pipeline. Therefore, the problem of the accumulative error of the positioning of the temperature-measurement point is further solved on the basis of a positioning algorithm, namely, when there are a plurality of rows of high-temperature pipeline, a temperature-measurement central point of the sensing temperature-measurement optical fibers is calibrated by the following method:
1) for the first row of pipelines, the positioning algorithm is directly adopted, namely (L0+L1/2) is an integral multiple of (L1+L2); and for a subsequent row of pipelines, the length basis is that the length L3 of the optical fiber from the tail end of the last straight line section in the previous row to the starting end of the first straight line section in the next row is an integral multiple of (L1+L2);
2) for the subsequent row of pipelines, a single-point temperature heater is adopted, the straight line on the first pipeline in the subsequent row of pipelines is attached to the optical fibers for heating, and the position change of an AD sampling peak value is observed by moving the position of a heating point of the heater along the optical fibers;
3) the heater moves from the entering direction of the optical fibers of the pipeline; if the position change of the AD sampling peak value is caused by the minor change of the position, the position A1 is recorded; the heater continuously moves towards the direction of connecting a second pipeline, and the position of the AD sampling peak value is unchanged at the moment; and the heater continuously moves until the position of the AD sampling peak value is changed for the second time, and the position is recorded as A2. The midpoints of the positions A1 and A2 are calculated, and if the midpoint is deviated from the position of the midpoint of the actual pipeline, a deviation value ΔA is calculated;
4) because the spacing between the rows of the shaping frame is adjustable, the deviation value ΔA can be compensated by adjusting the length of the optical fibers connecting the rows, namely the accumulative error is compensated;
5) by analogy, the initial positioning accuracy of each row may be ensured. In actual application, there are 10-20 pipelines in each row; it is assumed that the length of the optical fiber (L1+L2) on each pipeline is 1 m, the length of the optical fibers in single row is in the magnitude of dozens of meters, so the application of the above compensation method does not necessarily need to be for the first optical fibers in each row, and it may be spaced out in multiple rows and implemented when the photometric length reaches several hundred meters, reducing the workload of position calibration; and
6) the positioning accuracy of the temperature-measurement points of all the pipelines may be ensured by combining the above compensation method with the positioning method.

It is to be noted that the arc connecting section according to the present invention may be in a standard arc shape, or an arc shape with similar effects or an arc-shaped combined straight line shape, and only the stainless steel capillary tube with the sensing temperature-measurement optical fibers needs to be smoothly bent and shaped.

In summary, by the adoption of the foregoing technical solutions, according to the distributed optical fiber temperature-measurement system for a high-temperature pipeline group, because the sensing optical fiber is shaped and strictly fixed in length and straight, the position precision of the sensing optical fibers is guaranteed by machining precision; and high-precision temperature detection positioning can be easily achieved in software programming, and accumulative errors can be conveniently adjusted and eliminated. In addition, the whole strictly-shaped optical fibers can be matched with a row of boiler high-temperature pipelines at a time, and thus measurement precision losses or programming debugging difficulty caused by random processing is avoided in view of mounting.

### BRIEF DESCRIPTION OF THE DRAWINGS

FIG. 1 is an overall structural diagram of a distributed optical fiber temperature measurement system for a high-temperature pipeline group of the present invention.

FIG. 1a is an enlarged view of a stainless steel capillary tube with sensing temperature-measurement optical fibers embedded in an optical fiber shaping bent frame.

FIG. 2 is a structural diagram of an optical fiber shaping bent frame in FIG. 1.

FIG. 3 is a structural diagram of a single-row optical fiber shaping frame in FIG. 2.

FIG. 4 is a schematic diagram of a combination of shaping modules in FIG. 3.

FIG. 5 is a schematic diagram of a fixing structure of a single-row optical fiber shaping frame in FIG. 3.

FIG. 6 is a structural diagram of a long shaping plate module in FIG. 4.

FIG. 7 is a structural diagram of a short shaping plate module in FIG. 4.

FIG. 8 is a structural diagram of an arc connecting shaping plate module in FIG. 4.

FIG. 9 is a structural schematic diagram of a pressing plate.

FIG. 10 is a structural diagram of one stainless steel capillary tube with sensing temperature-measurement optical fibers and a high-temperature-resistant shaping plate.

FIG. 11 is a structural schematic diagram of one stainless steel capillary tube with sensing temperature-measurement optical fibers shown in FIG. 10 connected to a row of high-temperature pipelines.

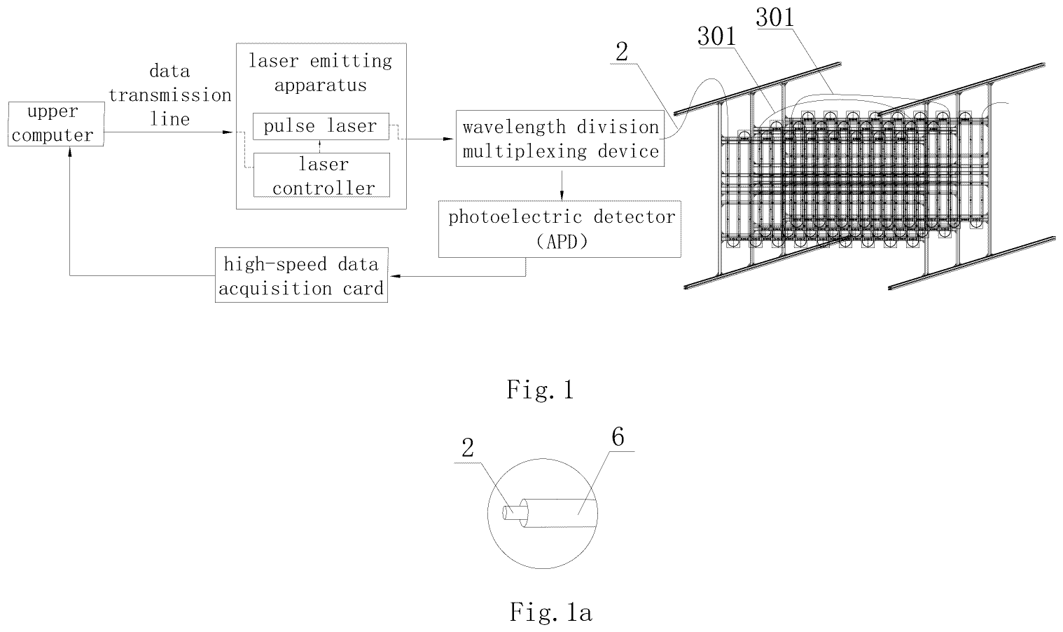

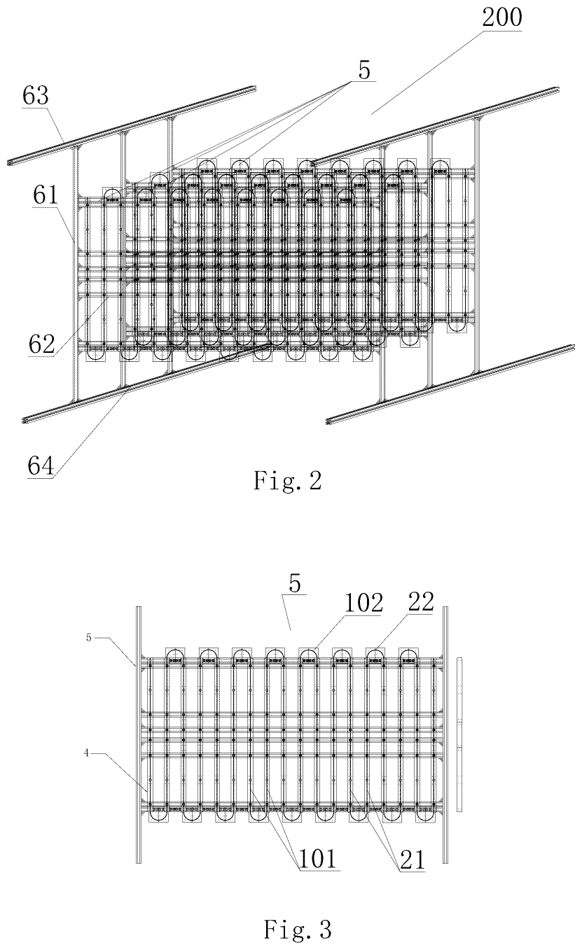

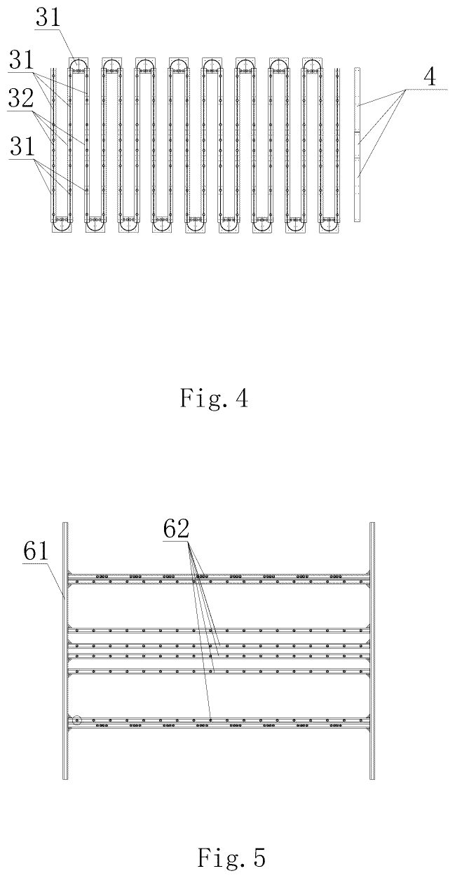

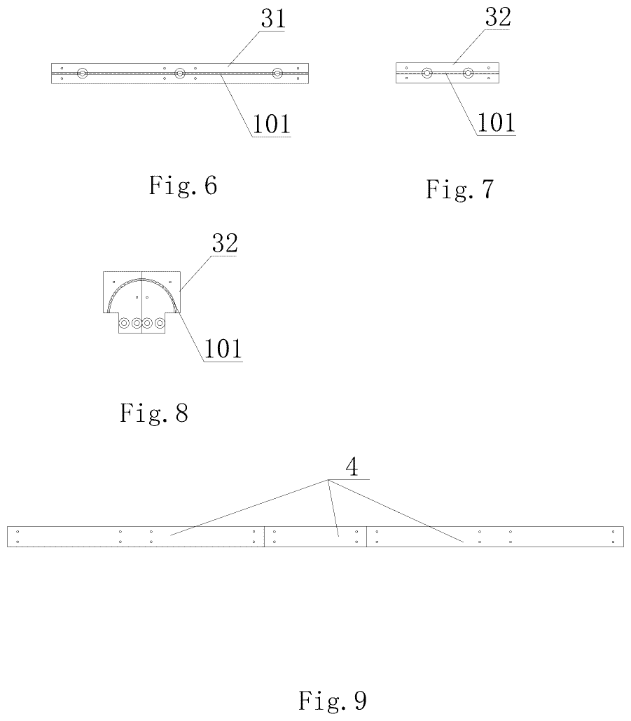

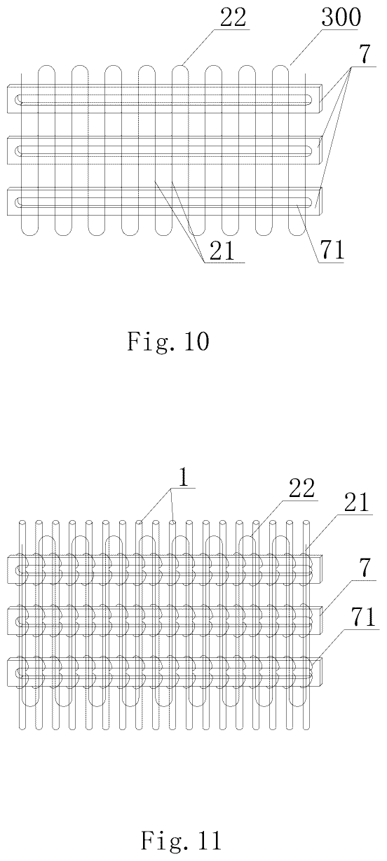

### DETAILED DESCRIPTION

The present invention will be further described below in conjunction with the accompanying drawings.

Referring to the figures, the present invention provides a distributed optical fiber temperature measurement system for a high-temperature pipeline group, including an upper computer, a data transmission line, a laser emitting apparatus, a wavelength division multiplexing device, a photoelectric detector, a data acquisition card, and sensing temperature-measurement optical fibers 2; a stainless steel capillary tube 6 is provided outside each sensing temperature-measurement optical fiber 2; the upper computer can adopt intelligent terminals such as microprocessors, controllers, and computers, the upper computer is connected with the laser emitting apparatus via the data transmission line, the laser emitting apparatus is composed of a pulse laser and a laser controller. The upper computer sends instructions to the laser controller through the data transmission line to adjust the pulse width, pulse intensity and pulse frequency of the emitted laser. The laser emitting apparatus is connected to the wavelength division multiplexing device, and the wavelength division multiplexing device is connected to one end of the sensing temperature-measurement optical fiber 2, and the pulse laser is injected into the sensing temperature-measurement optical fiber 2 through the wavelength division multiplexing device, to form spontaneous back Raman scattering. Two Raman scattered lights are Stokes light and anti-Stokes light. The reflected light passes through the wavelength division multiplexing device and is received, amplified and filtered by the photoelectric detector, and data are collected by two channels of the high-speed data acquisition card and transmitted to the upper computer for processing; the optical fibers 2 are placed in the stainless steel capillary tube 6, and are shaped by optical fiber shaping frames 5 to form a single-optical-fiber multi-path back-and-forth zigzag structural form matched with a plurality of high-temperature pipelines 1 in a single row; the back-and-forth zigzag form comprises a plurality of columns of straight line sections 21 and arc connecting sections 22 between every two adjacent columns of straight line sections; the straight line sections 21 are shaped to be straight and fixed in length by the optical fiber shaping frames, the straight line sections are equal in length, and the arc connecting sections are equal in length; and the sensing temperature-measurement optical fibers 2 are communicated from one end of the multi-path back-and-forth zigzag form to the other end, and the straight line sections 21 are fixed on different parallel high-temperature pipelines 1 one by one by means of the stainless steel capillary tubes 6 on the outer sides of the straight line sections.

When implementing the present invention, it is particularly necessary to build the optical fiber shaping frame 5 in advance to construct a temperature-measurement optical fiber sensor structure that fits the high-temperature pipelines to be measured. The optical fiber shaping frame designed by the present invention, as a means of constructing the temperature-measurement optical fiber sensor structure of the high-temperature pipelines, can realize rapid shaping of temperature-measurement optical fibers for high-temperature pipelines, and is a preprocessing link for on-site optical fiber installation. Based on the optical fiber sensor structure constructed by this shaping frame, the temperature measurement accuracy and temperature measurement positioning of the temperature measurement system can be tested and calibrated in advance on the shaping frame, and ultimately the temperature-measurement optical fibers can be quickly installed on site while ensuring the technical performance of the system, to meet the time limit for maintenance operation. Meanwhile, considering that the length and spacing of high-temperature pipelines in different superheater groups and the spacing between rows are different, in order to ensure the temperature measurement accuracy, temperature measurement positioning accuracy and rapid installation requirements, an optical fiber shaping frame is built using a plurality of shaping modules with standardized length or arc based on the known parameters such as length and spacing, which is conducive to the unification and standardization of fiber optic sensor structures and adapts to the characteristics of different high-temperature pipelines, as described in detail below.

The optical fiber shaping frame 5 is provided with a back-and-forth zigzag positioning groove matched with the stainless steel capillary tube 6; the back-and-forth zigzag positioning groove includes a plurality of columns of linear positioning grooves 101, and arc connecting positioning grooves 102 between two adjacent columns of linear positioning grooves at the front and rear, and the spacing between the linear positioning grooves 101 corresponds to the spacing between every two adjacent high-temperature pipelines; and the cross section size of the positioning grooves 101, 102 meets the requirement that part of the stainless steel capillary tube 6 can be embedded.

The back-and-forth zigzag positioning groove is formed by combining a plurality of shaping modules, and the shaping modules include linear long shaping plate modules 31, linear short shaping plate modules 32 and arc connecting shaping plate modules 33; different shaping modules can be composed of aluminum alloy plate notch grooves with different lengths and widths. Linear positioning grooves are formed in the surfaces of the linear long shaping plate modules 31 and the surfaces of the linear short shaping plate modules 32; arc connecting positioning grooves 102 are formed in the surfaces of the arc connecting shaping plate modules 33; the positioning grooves of the adjacent shaping modules are joined and communicated.

The shaping modules are further provided with pressing plates 4; and the pressing plates 4 are connected with the shaping modules and used for pressing, shaping and straightening optical fibers. The pressing plate 4 may be of the same length as the shaping module, or may not necessarily be of the same length, and may be connected to the shaping module through screws.

Accordingly, after the optical fiber shaping frame of the present invention is shaped, the optical fibers do not have unnecessary bending that affects the length and distance and avoids errors. In this way, the optical fibers can be accurately connected to the high-temperature pipelines according to the length range set by the program, to ensure accurate measurement. Since optical fibers can be attached to high-temperature pipelines straight and accurately positioned on the high-temperature pipelines (in the length range of the entire optical fiber), the length of optical fiber required to be adhered to each high-temperature pipeline can be greatly shortened. If there are multiple high-temperature pipelines in multiple rows, the amount of expensive optical fibers used will be greatly saved and the measurement accuracy will be improved.

As shown in the figure, in this embodiment, a column of linear positioning grooves is formed by combining two linear long shaping plate module 31 and one linear short shaping plate module 32; and the adjacent columns of linear positioning grooves are sequentially connected through the arc connecting shaping plate modules 33 to form the back-and-forth zigzag positioning groove. Under different circumstances, a column of straight line sections can be combined by other numbers of linear long shaping plate modules 31 and one linear short shaping plate module 32. By selecting the shaping modules, the length can be adjusted for different types of high-temperature pipelines. For the spacing of different high-temperature pipelines, arc connecting positioning grooves can be set through an arc connecting shaping plate module, or the arc connecting shaping plate module 33 can be divided into left and right halves to adjust the spacing between the left and right halves for the spacing of different types of high-temperature pipelines. Thus, while the optical fibers are being shaped, the straight line length and the bending connection length are accurately determined. In the measurement scenario of a plurality of high-temperature pipelines in multiple rows, the accumulative error that affects the measurement accuracy is avoided.

A fixing structure includes supporting frames on the two sides; the supporting frames on the two sides are provided with stand columns for single-row optical fiber shaping frames; cross beams 62 are connected between the stand columns 61 of the supporting frames on the two sides; a plurality of cross beams with different heights are arranged in the single-row optical fiber shaping frames; and a plurality of shaping module mounting positions are arranged on the cross beams in the length direction so as to adjust the spacing between different rows of shaping modules to be matched with the spacing change between the high-temperature pipelines on a test site. Each shaping module is mounted on the cross beam 61 through screws.

The supporting frame includes an ejector rod 63 and a base 64; a stand column 61 is connected between the ejector rod 63 and the base 64; the stand column 61 is connected with the ejector rod and the base in a position-adjustable mode, for example, profiles with slide rails are used on the ejector rod and the base respectively. The stand column 61 is provided with a connecting base that can slide along the slide rails and adjust the position steplessly. After the adjustment is in place, it is locked with screws so that the spacing for high-temperature pipelines in different rows can be adapted in a standardized manner.

The sensing temperature-measurement optical fibers are shaped through the following steps:
Step (1): adjusting the number of the single-row optical fiber shaping frames in an optical fiber shaping bent frame 200 and the distance between the single-row optical fiber shaping frames 5 in the adjacent rows according to the row number of the high-temperature pipelines 1, the row-to-row spacing, the spacing between the high-temperature pipelines in each row and the length of the single high-temperature pipeline in the test site, selecting proper shaping modules, and determining the spacing between linear positioning grooves in the single-row optical fiber shaping frames and the length of the linear positioning grooves;
Step (2): enabling one end of the stainless steel capillary tube 6 with the sensing temperature-measurement optical fibers 2 to enter from one end of the optical fiber positioning groove of the single-row optical fiber shaping frame in the first row in the optical fiber shaping bent frame and exit from the other end, and then entering the optical fiber positioning groove of the single-row optical fiber shaping frame 5 in the next row from one end and exiting from the other end in the same manner until one end of the stainless steel capillary tube enters from one end of the optical fiber positioning groove of the single-row optical fiber shaping frame 5 in the last row and exits from the other end; and
Step (3): fixing the pressing plates 4 to the shaping modules of the optical fiber shaping bent frame, and flattening the stainless steel capillary tube 6 with the sensing temperature-measurement optical fibers 2 so that the stainless steel capillary tube 6 with the sensing temperature-measurement optical fibers 2 forms a plurality of back-and-forth zigzag shapes 300, the spacing between two adjacent straight line sections 101 in the same back-and-forth zigzag shape corresponds to the spacing between two adjacent high-temperature pipelines 1 in the same row, and the spacing between the stainless steel capillary tubes 301 with the sensing temperature-measurement optical fibers connected between the adjacent back-and-forth zigzag shapes 300 is matched with the spacing between the adjacent high-temperature pipelines.

A distributed optical fiber temperature-measurement system is further provided with a high-temperature-resistant shaping plate 7; a groove 70 is provided on one side of the high-temperature-resistant shaping plate 7 for placing glue bonded to the stainless steel capillary tube 301. After being successfully shaped, the optical fibers are accurately mounted on the high-temperature pipelines 1 at a time through the following steps:
Step (1): after the stainless steel capillary tube 6 with the sensing temperature-measurement optical fibers 2 are successfully shaped, taking down the pressing plates 4, connecting the outer side surface of the stainless steel capillary tube 6 with the sensing temperature-measurement optical fibers 2 on the each single-row optical fiber shaping frame 5 to the high-temperature-resistant shaping plate 7, and taking down the high-temperature-resistant shaping plate 7 connected with the stainless steel capillary tube 6 with the sensing temperature-measurement optical fibers 2 from each optical fiber shaping frame 5 to form a plurality of mounting structures (accurate and easy to transport) which can be overlapped but are connected with one another and are communicated with one another from one ends to the other ends of the stainless steel capillary tubes with the sensing temperature-measurement optical fibers;
step (2): inserting a single-row high-temperature-resistant plate fixedly provided with one stainless steel capillary tube with the sensing temperature-measurement optical fibers into the front of a corresponding row of high-temperature pipelines on the test site, enabling the stainless steel capillary tube at the straight line section to be in one-to-one correspondence with each high-temperature pipeline, and attaching and fixing the stainless steel capillary tube at the straight line section to the high-temperature pipelines, or bundling steel wires to strengthen the fixation.

Further, every two back-and-forth zigzag stainless steel capillary tubes with the sensing temperature-measurement optical fibers are arranged face to face, and the workload in the mounting process is reduced.

Through the above embodiment, the optical fibers are shaped by an optical fiber shaping frame to be an integral multiple of (L0+L1/2) to (L1+L2); wherein, L0 is the length of a single-path optical fiber connected to the starting position of an optical fiber straight line section corresponding to a first high-temperature pipeline by a wavelength division multiplexing device, L1 is the length of the optical fiber straight line section, and L2 is the length between the tail end of the previous optical fiber straight line section and the starting point of the next optical fiber straight line section in the same row.

For the connecting optical fibers between the rows of pipelines, the optical fiber length L3 from the tail end of the last straight line section in the previous row to the starting end of the first straight line section in the next row is an integral multiple of (L1+L2), or the length obtained after accumulative error elimination treatment is carried out on the basis of the integral multiple of (L1+L2).

A temperature-measurement central point of the sensing temperature-measurement optical fibers is calibrated by the following method:
1) for the first row of pipelines, the temperature-measurement central point is determined directly by adopting (L0+L1/2) as an integral multiple of (L1+L2); and for a subsequent row of pipelines, the length basis is that the length L3 of the optical fiber from the tail end of the last straight line section in the previous row to the starting end of the first straight line section in the next row is an integral multiple of (L1+L2);
2) for the subsequent row of pipelines, a single-point temperature heater is adopted, the straight line on the first pipeline in the subsequent row of pipelines is attached to the optical fibers for heating, and the position change of an AD sampling peak value is observed by moving the position of a heating point of the heater along the optical fibers;
3) the heater moves from the entering direction of the optical fibers of the pipeline; if the position change of the AD sampling peak value is caused by the minor change of the position, the position A1 is recorded; the heater continuously moves towards the direction of connecting a second pipeline, and the position of the AD sampling peak value is unchanged at the moment; and the heater continuously moves until the position of the AD sampling peak value is changed for the second time, and the position is recorded as A2. The midpoints of the positions A1 and A2 are calculated, and if the midpoint is deviated from the position of the midpoint of the actual pipeline, a deviation value ΔA is calculated;
4) the deviation value ΔA is compensated by adjusting L3, i.e., the accumulative error is compensated;
5) by analogy, based on the optical fiber shaping standard structure of the present invention, the initial positioning accuracy of each row can be ensured very conveniently and accurately.

Therefore, based on the high-precision optical fiber sensor structure adapted to the measured high-temperature pipeline group of the present invention, high-precision temperature detection and positioning can be easily achieved in software programming, and the accumulative errors can be conveniently adjusted and eliminated. According to the technical solutions of the present invention, the accuracy and stability of temperature measurement can be improved. According to the description of the above specific embodiments of the present invention, the present invention realizes the linear installation of optical fibers along high-temperature pipelines very conveniently, reduces the impact of deformation of high-temperature pipelines, does not cause tilt and distortion, etc., and improves the consistency of temperature measurement.

Meanwhile, the optical fiber sensor structure of the present invention can be mounted using a high-temperature-resistant shaping plate to fix the structural shape of the optical fiber sensor after shaping. During the actual mounting, the entire structure can be bonded to the high-temperature pipelines through high-temperature glue, which not only ensures the accuracy of optical fiber temperature measurement, consistency, stability and reliability of temperature measurement and positioning accuracy of temperature measurement, but also meets the mounting requirements in a short time.

The foregoing embodiments are only used to describe the present invention rather than limit the present invention. Those skilled the art can make various changes and modifications without departing from the spirit and scope of the present invention. Therefore, all equivalent technical solutions also fall within the scope of the present invention, and the patent protection scope of the present invention shall be defined by the appended claims.

1. A distributed optical fiber temperature measurement system for a high-temperature pipeline group, comprising an upper computer, a data transmission line, a laser emitting apparatus, a wavelength division multiplexing device, a photoelectric detector, a high-speed data acquisition card, and sensing temperature-measurement optical fibers; a stainless steel capillary tube is provided outside each sensing temperature-measurement optical fiber; wherein the optical fibers are placed in the stainless steel capillary tube, and are shaped by optical fiber shaping frames to form a single-optical-fiber multi-path back-and-forth zigzag structural form matched with a plurality of high-temperature pipelines in a single row; the back-and-forth zigzag form comprises a plurality of columns of straight line sections and arc connecting sections between every two adjacent columns of straight line sections; the straight line sections are shaped to be straight and fixed in length by the optical fiber shaping frames, the straight line sections are equal in length, and the arc connecting sections are equal in length; and the sensing temperature-measurement optical fibers are communicated from one end of the multi-path back-and-forth zigzag form to the other end, and the straight line sections are fixed on different parallel high-temperature pipelines one by one by means of the stainless steel capillary tubes on the outer sides of the straight line sections;
the optical fibers are shaped by an optical fiber shaping frame to be an integral multiple of (L0+L1/2) to (L1+L2); wherein, L0 is the length of a single-path optical fiber connected to the starting position of an optical fiber straight line section corresponding to a first high-temperature pipeline by a wavelength division multiplexing device, L1 is the length of the optical fiber straight line section, and L2 is the length between the tail end of the previous optical fiber straight line section and the starting point of the next optical fiber straight line section in the same row;
the optical fiber shaping frame is provided with a back-and-forth zigzag positioning groove matched with the stainless steel capillary tube; the back-and-forth zigzag positioning groove includes a plurality of columns of linear positioning grooves, and arc connecting positioning grooves between two adjacent columns of linear positioning grooves at the front and rear, and the spacing between the linear positioning grooves corresponds to the spacing between every two adjacent high-temperature pipelines; and the cross section size of the positioning groove meets the requirement that part of the stainless steel capillary tube can be embedded.

2. The distributed optical fiber temperature measurement system for a high-temperature pipeline group of claim 1, wherein for the connecting optical fibers between the rows of pipelines, the optical fiber length L3 from the tail end of the last straight line section in the previous row to the starting end of the first straight line section in the next row is an integral multiple of (L1+L2), or the length obtained after accumulative error elimination treatment is carried out on the basis of the integral multiple of (L1+L2).

3. The distributed optical fiber temperature measurement system for a high-temperature pipeline group according to claim 1, wherein when there are a plurality of rows of high-temperature pipelines, the accumulative error is eliminated by adjusting the length of the connecting optical fibers between the rows.

4. The distributed optical fiber temperature measurement system for a high-temperature pipeline group according to claim 3, wherein when there are a plurality of rows of high-temperature pipeline, a temperature-measurement central point of the sensing temperature-measurement optical fibers is calibrated by the following method:
1) for the first row of pipelines, the temperature-measurement central point is determined directly by adopting (L0+L1/2) as an integral multiple of (L1+L2); and for a subsequent row of pipelines, the length basis is that the length L3 of the optical fiber from the tail end of the last straight line section in the previous row to the starting end of the first straight line section in the next row is an integral multiple of (L1+L2);
2) for the subsequent row of pipelines, a single-point temperature heater is adopted, the straight line on the first pipeline in the subsequent row of pipelines is attached to the optical fibers for heating, and the position change of an AD sampling peak value is observed by moving the position of a heating point of the heater along the optical fibers;
3) the heater moves from the entering direction of the optical fibers of the pipeline; if the position change of the AD sampling peak value is caused by the minor change of the position, the heating point position A1 is recorded; the heater continuously moves towards the direction of connecting a second pipeline, and the position of the AD sampling peak value is unchanged at the moment; and the heater continuously moves until the position of the AD sampling peak value is changed for the second time, and the heating point position is recorded as A2; the midpoints of the heating point positions A1 and A2 are calculated, and if the midpoint is deviated from the position of the midpoint of the actual pipeline, a deviation value ΔA is calculated;
4) the deviation value ΔA is compensated by adjusting L3;
5) by analogy, the initial positioning accuracy of each row can be ensured.

5. The distributed optical fiber temperature measurement system for a high-temperature pipeline group according to claim 1, wherein the back-and-forth zigzag positioning groove is formed by combining a plurality of shaping modules, and the shaping modules comprise linear long shaping plate modules, linear short shaping plate modules and arc connecting shaping plate modules; linear positioning grooves are formed in the surfaces of the linear long shaping plate modules and the surfaces of the linear short shaping plate modules; arc connecting positioning grooves are formed in the surfaces of the arc connecting shaping plate modules, the positioning grooves of the adjacent shaping modules are joined and communicated, the shaping modules are further provided with pressing plates, and the pressing plates are connected with the shaping modules and used for pressing, shaping and straightening optical fibers.

6. The distributed optical fiber temperature measurement system for a high-temperature pipeline group according to claim 5, wherein a fixing structure of the optical fiber shaping frame comprises supporting frames on the two sides, the supporting frames on the two sides are provided with connecting structures for single-row optical fiber shaping frames, cross beams are connected between the connecting structures of the supporting frames on the two sides, a plurality of cross beams with different heights are arranged in the single-row optical fiber shaping frames, and a plurality of shaping module mounting positions are arranged on the cross beams in the length direction so as to adjust the spacing between different rows of shaping modules to be matched with the spacing change between the high-temperature pipelines on a test site;
the supporting frame comprises an ejector rod and a base, a stand column is connected between the ejector rod and the base; the cross beams are connected with the stand column, and the stand column is connected with the ejector rod and the base in a position-adjustable mode.

7. The distributed optical fiber temperature measurement system for a high-temperature pipeline group according to claim 6, wherein the sensing temperature-measurement optical fibers are shaped through the following steps:
Step (1): adjusting the number of the single-row optical fiber shaping frames in an optical fiber shaping bent frame and the distance between the single-row optical fiber shaping frames in the adjacent rows according to the row number of the high-temperature pipelines, the row-to-row spacing, the spacing between the high-temperature pipelines in each row and the length of the single high-temperature pipeline in the test site, selecting proper shaping modules, and determining the spacing between linear positioning grooves in the single-row optical fiber shaping frames and the length of the linear positioning grooves;
Step (2): enabling one end of the stainless steel capillary tube with the sensing temperature-measurement optical fibers to enter from one end of the optical fiber positioning groove of the single-row optical fiber shaping frame in the first row in the optical fiber shaping bent frame and exit from the other end, and then entering the optical fiber positioning groove of the single-row optical fiber shaping frame in the next row from one end and exiting from the other end in the same manner until one end of the stainless steel capillary tube enters from one end of the optical fiber positioning groove of the single-row optical fiber shaping frame in the last row and exits from the other end; and
Step (3): fixing the pressing plates to the shaping modules of the optical fiber shaping bent frame, and flattening the stainless steel capillary tube with the sensing temperature-measurement optical fibers so that the stainless steel capillary tube with the sensing temperature-measurement optical fibers forms a plurality of back-and-forth zigzag shapes, the distance between two adjacent straight line sections in the same back-and-forth zigzag shape corresponds to the distance between two adjacent high-temperature pipelines in the same row, and the distance between the stainless steel capillary tubes with the sensing temperature-measurement optical fibers connected between the adjacent back-and-forth zigzag shapes is matched with the distance between the adjacent high-temperature pipelines.

8. The distributed optical fiber temperature measurement system for a high-temperature pipeline group according to claim 7, wherein a distributed optical fiber temperature-measurement system is further provided with a high-temperature-resistant shaping plate; after being successfully shaped, the optical fibers are accurately mounted on the high-temperature pipelines at a time through the following steps:
Step (1): after the stainless steel capillary tube with the sensing temperature-measurement optical fibers are successfully shaped, taking down the pressing plates, connecting the outer side surface of the stainless steel capillary tube with the sensing temperature-measurement optical fibers on each single-row optical fiber shaping frame to the high-temperature-resistant shaping plate, and taking down the high-temperature-resistant shaping plate connected with the stainless steel capillary tube with the sensing temperature-measurement optical fibers from each optical fiber shaping frame to form a plurality of mounting structures which can be overlapped but are connected with one another and are communicated with one another from one ends to the other ends of the stainless steel capillary tubes with the sensing temperature-measurement optical fibers; and
Step (2): inserting a single-row high-temperature-resistant plate fixedly provided with one stainless steel capillary tube with the sensing temperature-measurement optical fibers into the front of a corresponding row of high-temperature pipelines on the test site, enabling the stainless steel capillary tube at the straight line section to be in one-to-one correspondence with each high-temperature pipeline, and attaching and fixing the stainless steel capillary tube at the straight line section to the high-temperature pipelines.
